(19) United States
(12) Patent Application Publication
(10) Pub. No.: US 2015/0074047 A1
(43) Pub. Date: Mar. 12, 2015

(54) MULTI-PROFILE SYNCHRONIZATION

(71) Applicant: Cisco Technology, Inc., San Jose, CA (US)

(72) Inventors: Laurent Gardes, Meudon (FR); Yann Joel Prat, Elancourt (FR); Didier De Marrez, Charenton-le-Pont (FR); Olivier Lacour, Paris (FR)

(21) Appl. No.: 14/316,577

(22) Filed: Jun. 26, 2014

Related U.S. Application Data
(60) Provisional application No. 61/877,118, filed on Sep. 12, 2013.

(51) Int. Cl. G06F 21/62; G06F 17/30

(52) U.S. Cl. CPC G06F 21/6245; G06F 17/30174
USPC 707/610

(57) ABSTRACT

Various embodiments provide an automated multi-device login synchronization function. For example, a private computing device, such as a smartphone or table computer, can detect a shareable device, such as a television set top box or video game consul, when the private device enters a room. In one example, the private device can determine whether the shareable device is currently associated with one or more user profiles. If the shareable device is not associated with a user profile, a command can be sent, by the private device to apply user settings and/or preferences for, and make content associated with, a user profile associated with the private computing device available on the shareable device. If, however, the shareable device is associated with a second user profile, a similar command can be sent causing the shareable device to merge the first and second user profiles to create a merged profile.

### CROSS-REFERENCE TO RELATED APPLICATION

This application claims priority to U.S. Provisional Application No. 61/877,118, filed Sep. 12, 2013, the complete disclosure of which is incorporated herein by reference in its entirety.

### BACKGROUND

Users are able to access digital content through a variety of computing devices. For example, a user can start watching a movie on their television through an application on a set top box and finishing watching the movie through a corresponding application on their tablet computer. In many instances, the user can resume watching the movie on their tablet computer where they left off watching the movie on their television. This information, along with user preferences, content purchases, payment information, and the like, is stored in a user profile. Accordingly, these user profiles not only contain device specific information, they contain global profile information used by multiple devices. This information, however, typically contains a user's personal and financial information and, therefore, must be kept protected. Accordingly, a user typically accesses their user profile or account information by logging in with a username and password. Requiring a user to repeatedly login to keep this information secure, however, is cumbersome and is often a discouragement to the adoption of some profile-based systems. Further, many devices routinely log themselves out of any user profile after a certain period of time for security purposes. Accordingly, this problem is exacerbated as the number of devices a user associates with a user profile gets larger, which can result in the user having to provide the same login information to multiple devices within a relatively short period of time.

### BRIEF DESCRIPTION OF THE DRAWINGS

Various embodiments in accordance with the present disclosure will be described with reference to the drawings, in which:

FIG. 1A illustrates an example wherein a private computing device enters a room with a shareable computing device in accordance with at least one embodiment;

FIG. 1B illustrates an example wherein the private and shareable computing devices are each not logged into a user profile in accordance with at least one embodiment;

FIG. 1C illustrates an example wherein the private computing device logs into a user profile and is prompted to associate the shareable computing device with the user profile as the user enters the room in accordance with at least one embodiment;

FIG. 1D illustrates an example wherein the private computing device provides information for the user profile directly to the shareable computing device in accordance with at least one embodiment;

FIG. 1E illustrates an example wherein the private computing device provides the information for the user profile to a server which then provides corresponding information for the user profile to the shareable computing device in accordance with at least one embodiment;

FIG. 2A illustrates an example wherein a second private computing device enters the room with the first private computing device and the shareable device in accordance with at least one embodiment;

FIG. 2B illustrates an example wherein the first private and shareable computing devices are associated with a first user profile and the second private computing device is associated with a second user profile in accordance with at least one embodiment;

FIG. 2C illustrates an example wherein the second private computing device is prompted to merge the second user profile with the first user profile on the shareable computing device in accordance with at least one embodiment;

FIG. 2D illustrates an example wherein the shareable computing device is associated with the first and second user profiles in accordance with at least one embodiment;

FIG. 3A illustrates example content associated with a first user profile in accordance with at least one embodiment;

FIG. 3B illustrates example content associated with a second user profile in accordance with at least one embodiment;

FIG. 3C illustrates example content associated with a merged profile comprising content associated with the first and second user profiles in accordance with at least one embodiment;

FIG. 4 illustrates an example process for synchronizing user profiles that can be used in accordance with at least one embodiment; and

FIG. 5 illustrates an environment in which various embodiments can be implemented.

### DETAILED DESCRIPTION

Systems and methods in accordance with various embodiments of the present disclosure may overcome one or more of the aforementioned and other deficiencies experienced in conventional approaches to logging into a user profile via a computing device.

### Overview:

Various approaches provide an automated multi-device login synchronization function. For example, a private computing device, such as a smartphone or tablet computer, can detect a shareable device, such as a television set top box or video game consul, when the private device enters a room. Accordingly, the private device can determine, in one example, whether the shareable device is currently associated with one or more user profiles. Alternatively, the private device can send a request, through a network, to a server for shareable device profile information. In the instance the shareable device is not associated with a user profile, a command can be sent, by the private device directly or indirectly via the server, to apply user settings and/or preferences for, and make content associated with, the first user profile available on the shareable device. In the instance the shareable device is associated with a second user profile, however, a similar command can be sent causing the shareable device to merge the first and second user profiles to create a merged profile. There can be various settings and profile priorities associated with a merged profile. For example, there could be a device hierarchy based on permissions (e.g., a child's device may contain content restrictions where the parent's device does not), merge order (e.g., which profile was applied first), and the like. Accordingly, instead of merging profiles, priority settings could dictate that a second profile, when applied on a shareable device, will substitute any previously applied user profiles.

Various other functions and advantages are described and suggested below as may be provided in accordance with the various embodiments.

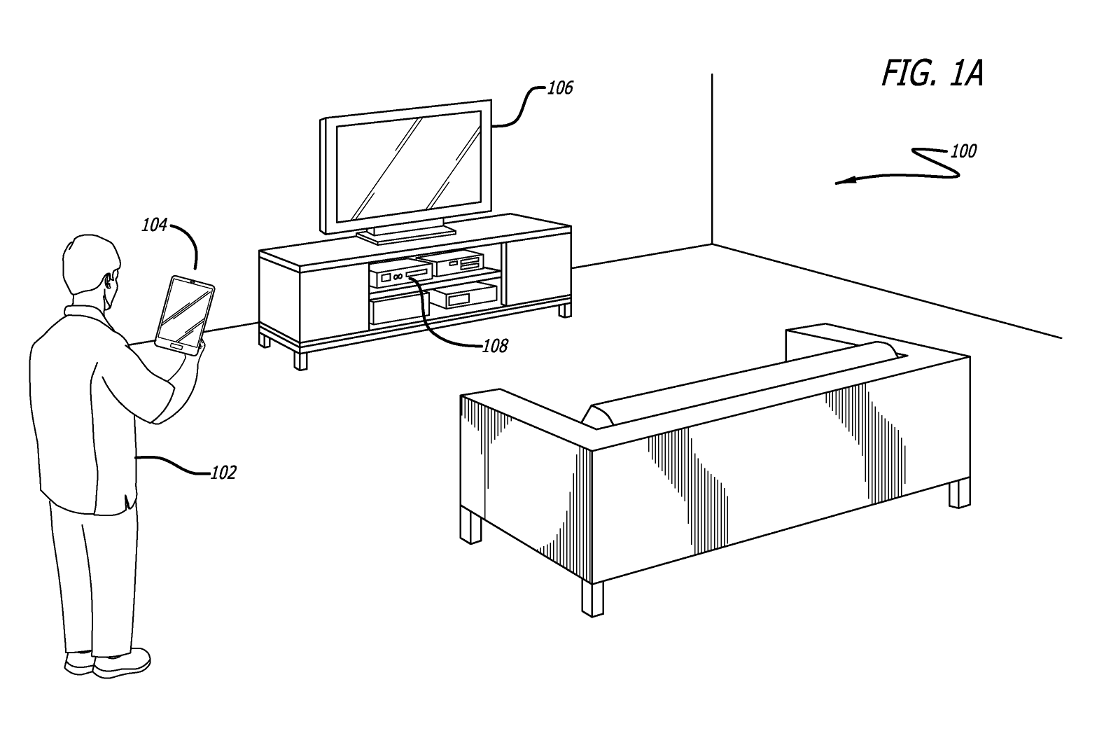

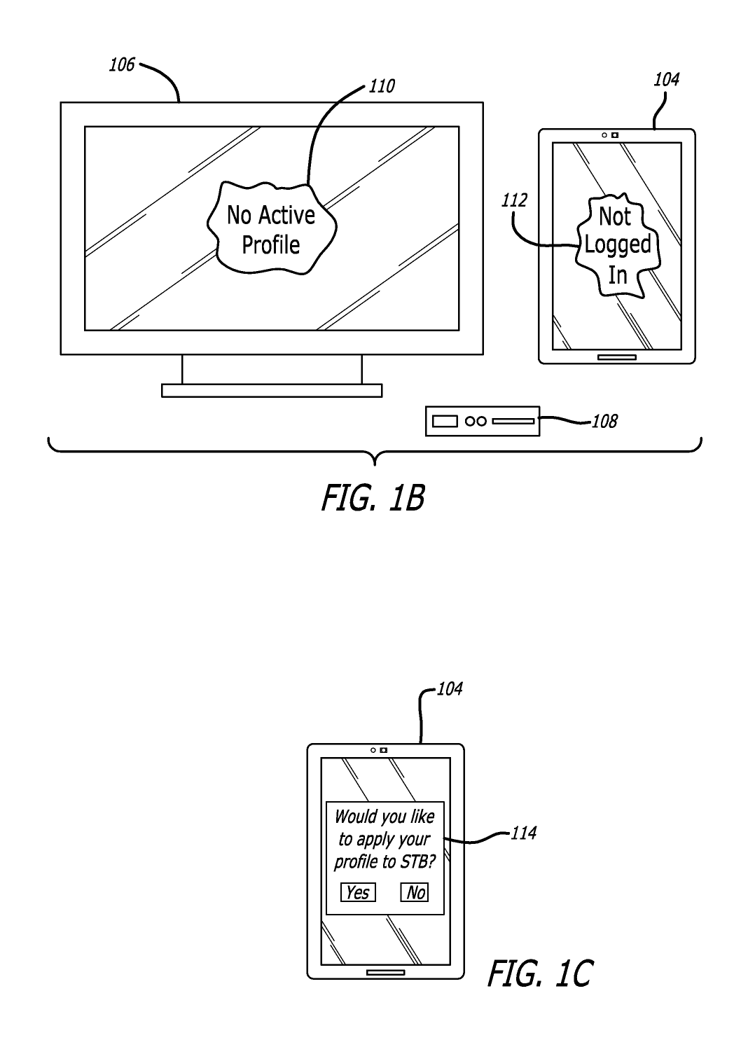

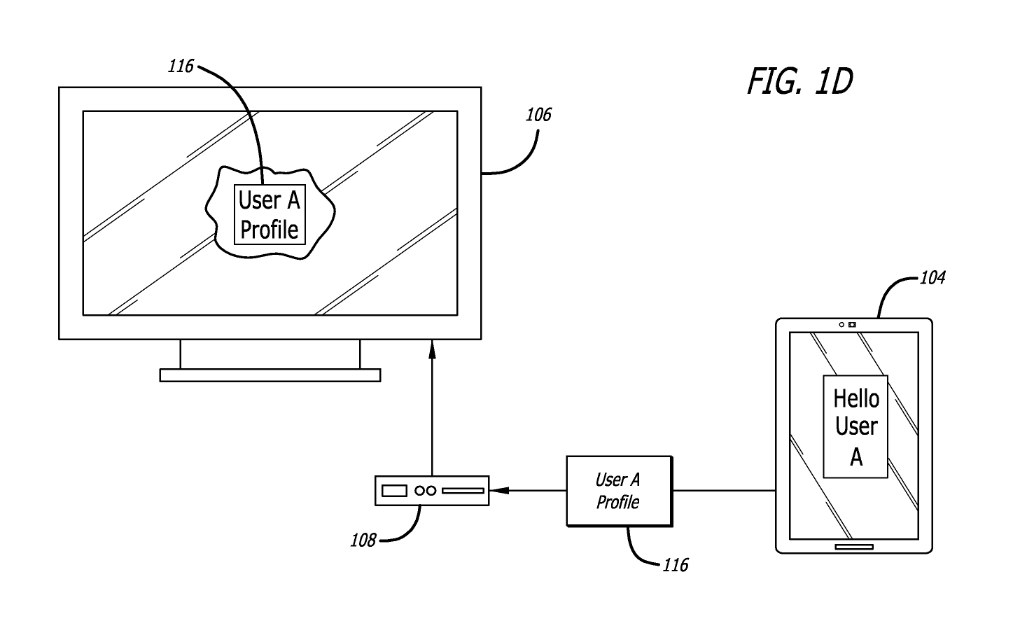

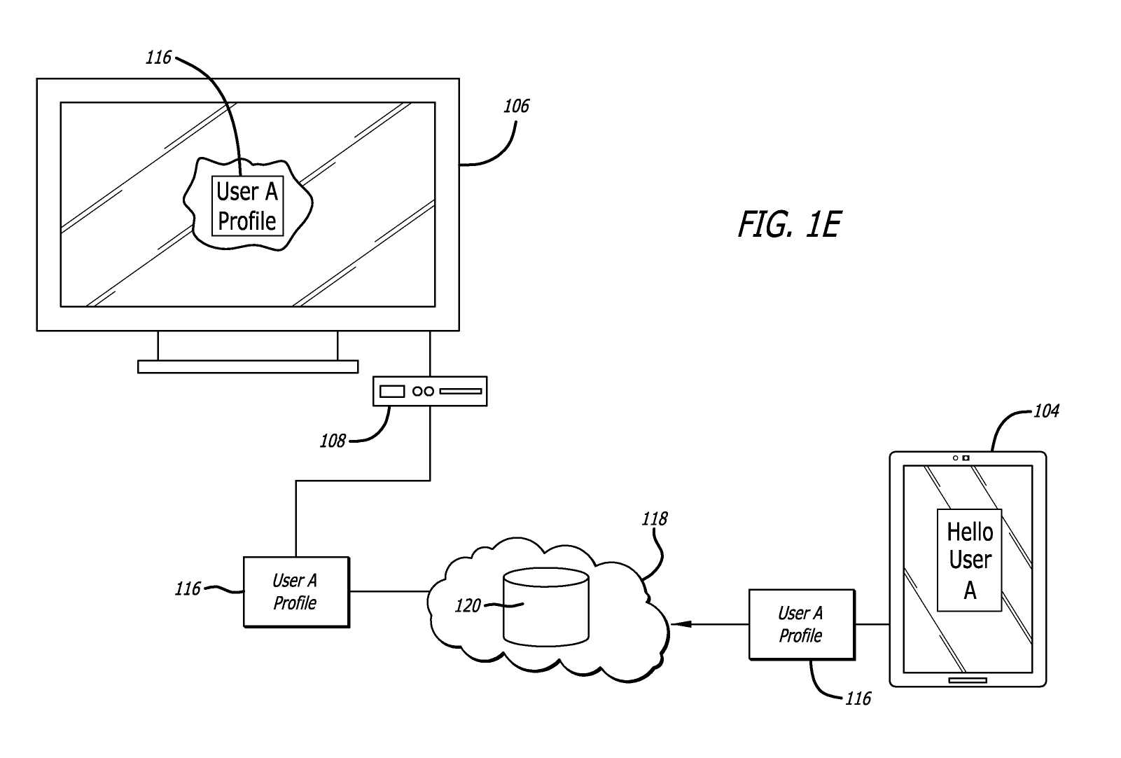

FIG. 1A illustrates example situation 100 wherein user 102, holding private computing device 104, enters the room containing shareable device 108 in accordance with various embodiments. Although private computing device 104 is illustrated as a mobile computing device (e.g., a smartphone or tablet computer), it should be understood that any device capable of receiving and processing input can be used in accordance with various embodiments discussed herein. These devices can include, for example, desktop computers, notebook computers, electronic book readers, phablets, smart watches, personal data assistants, cellular phones, video gaming consoles or controllers, smart televisions, television set top boxes, and portable media players, among others. Additionally, although shareable device 108 is illustrated as a device in communication with television 106 (e.g., set top box or video gaming console), it should be understood that these devices can include, for example, smart televisions or any of the aforementioned devices configured to support multiple user profiles. As used herein, a public device can be shared or have overlapping profiles with more than one user. By contrast, a private device is used by, and contains the user profile of, a single user. In most cases, a private device will not accept a profile substitution or merger. A public device, however, can accommodate many different profiles simultaneously.

In this example, when user 102 walks into the room, private device 104 detects the presence of shareable device 108 and determines whether shareable device 108 is currently associated with one or more user profiles. In this example, private device 104 can try to connect with shareable device 108 directly to determine whether it is associated with a user profile or, alternatively, private device 104 can send a request, through a network, to a cloud based server for profile information associated with shareable device 108. As used herein, a user profile contains personal data associated with a specific user's account with, for example, a media provider (e.g., cable television provider, streaming content provider, video game provider, etc.). This personal data can include a user's viewing and/or purchase history, account preference including visual display, notification, search, and sharing preferences, and reflect the user's viewing habits, viewing preference, viewing status, subscription plan(s) among others. Further, user 102 may have a subscription plan with the media provider and may connect to an associated media library, and the like.

Shareable device 108, in this example, is not associated with a user profile. Accordingly, FIG. 1B illustrates an example wherein both private device 104 and shareable device 108 are not logged into a user profile. Private device 104 can automatically (without user intervention), send a command, either directly or indirectly via the server, to apply user settings and/or preferences for, and make content associated with, the user profile of private device 104 available on the shareable device 108. Since, in this example, private device 104 is not logged in 112 to their profile or account, however, user 102 must first login on private device 104 before being able to push this profile to shareable device 108. Accordingly, FIG. 1C illustrates an example wherein an application or software (either on private device 104 or on the server) causes prompt 114, instructing user 102 to login to their user profile, to be displayed.

FIG. 1D illustrates an example wherein private device 104 has logged into user A profile 116 and has subsequently provided information for user A profile 116 directly to shareable device 108. Accordingly, once user 102 logs into user A profile 116, in this example, private device 104 provides information for user A profile 116 directly to shareable device 108, which then makes content, settings, and/or preferences associated with user A profile 116 available on television 106. Instead of private device 104 directly providing information for user A profile 116 to shareable device 108, a command can be sent to a cloud-based server, which determines any profile conversions, if necessary, and sends information for user A profile 116 to shareable device 108. Accordingly, FIG. 1E illustrates this example wherein private device 104 sends a command, through network 118, to server 120, to make the content, settings, and/or preferences associated with user A profile 116 available to shareable device 108 for viewing on television 106. In this example, server 120 is configured to store user profile information for many users including information for translating the content, settings, and/or preferences of a respective user profile from one device or operating system type to another and synchronizing the user profile information on each computing device associated with the respective user profile.

In one example, each computing device can communicate with server 120 through a piece of software that is associated with retrieving and setting profile parameters from other devices. This software component can, in one example, be integrated at the operating system level or at the application level. Additionally, some unmanaged devices, such as devices that do not have a cloud profile support system or have proprietary profile support, can also be supported. However, in the latter case, some gateways to and from unmanaged devices can be provided. These gateways (e.g., one per unsupported device type) may connect on one side to a cloud profile and on another side to a respective proprietary profile system associated with a particular device or account. Further, in some instances, certain profile parameters may be missing across synchronized devices, but all common parameters (e.g., a profile name minimum) can be exchanged and synchronized through the gateways.

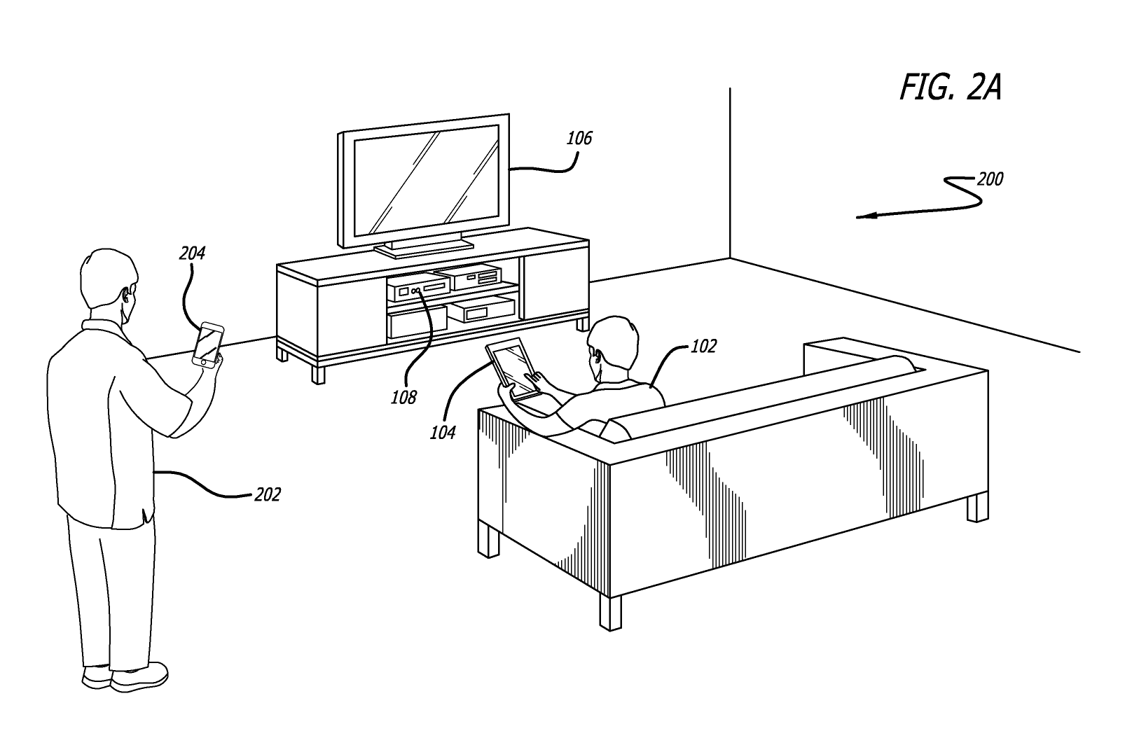

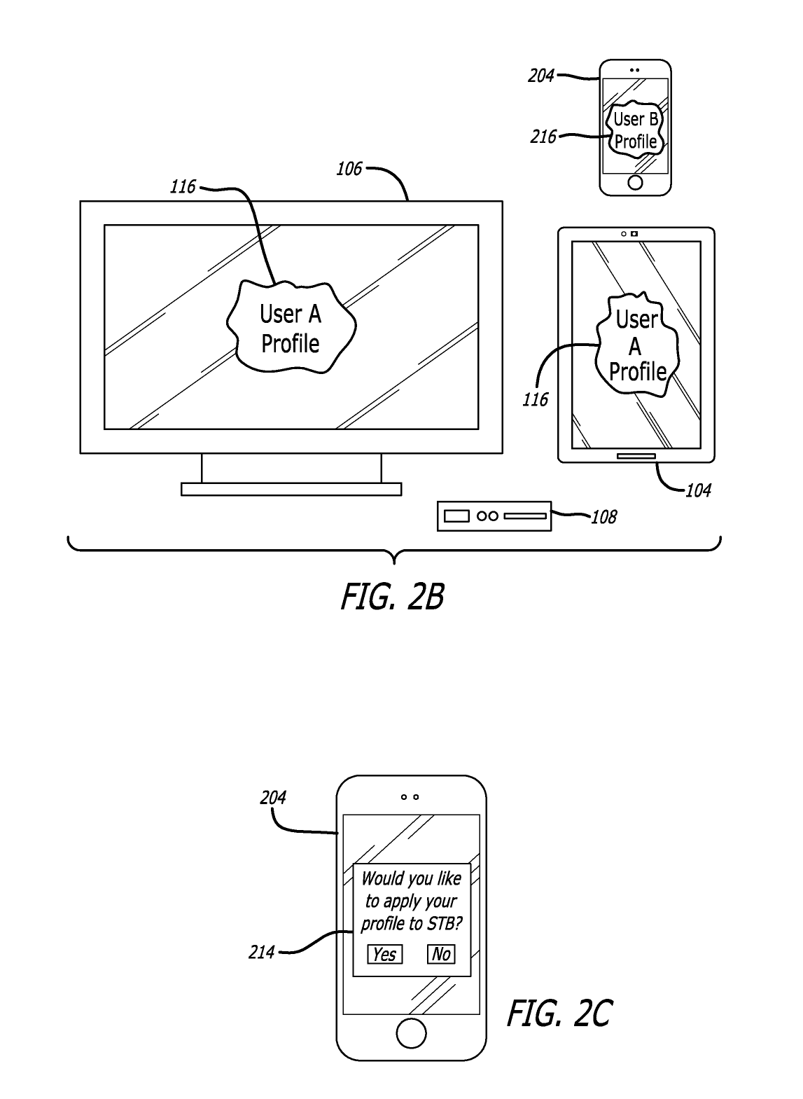

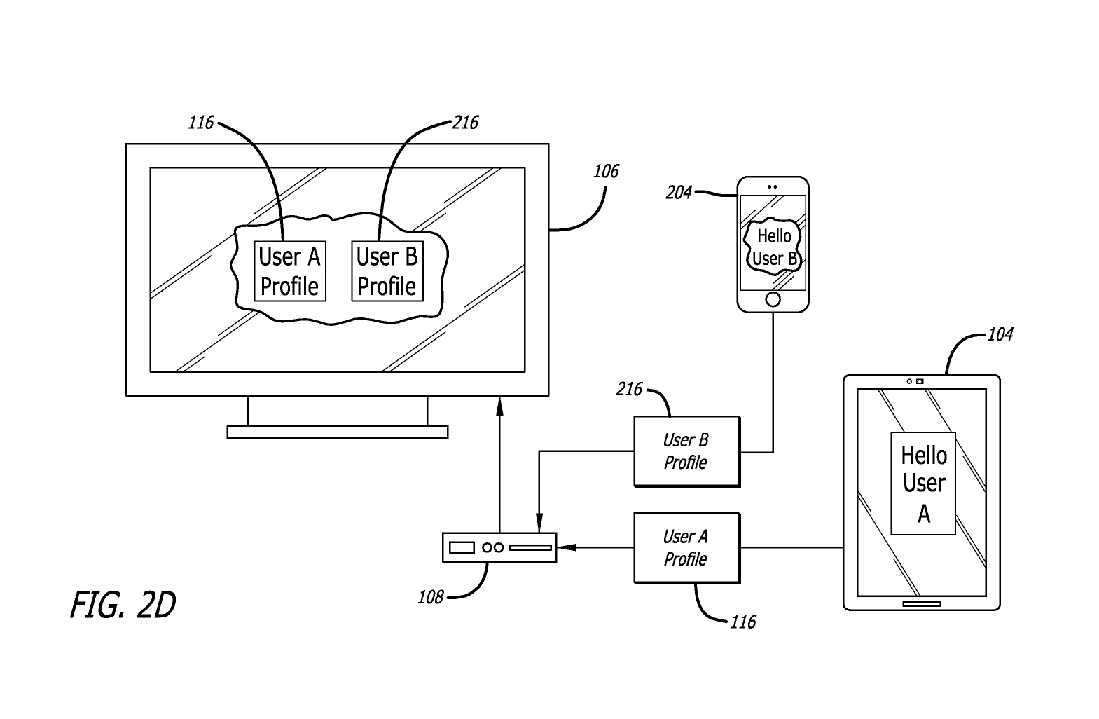

FIG. 2A illustrates an example wherein second user 202, holding second private device 204, enters the room with private device 104 and shareable device 108 in accordance with at least one embodiment. In this example, when second user 202 walks into the room, second private device 204 also detects the presence of shareable device 108 and determines whether shareable device 108 is currently associated with one or more user profiles, as discussed with respect to FIG. 1A. In this example, however, shareable device 108 is already profiled with user A profile 116. Accordingly, FIG. 2B illustrates an example wherein private device 104 and shareable device 108 (as shown on television 106 in communication with shareable device 108) are associated with user A profile 116 and second private device 204 is associated with second user B profile 216. In this example, second private device 204 can automatically (without user intervention) cause a command to be sent, either directly or indirectly via server 120 as discussed above, to apply user settings and/or preferences for, and make content associated with, second user B profile 216 of second private device 204 available on shareable device 108.

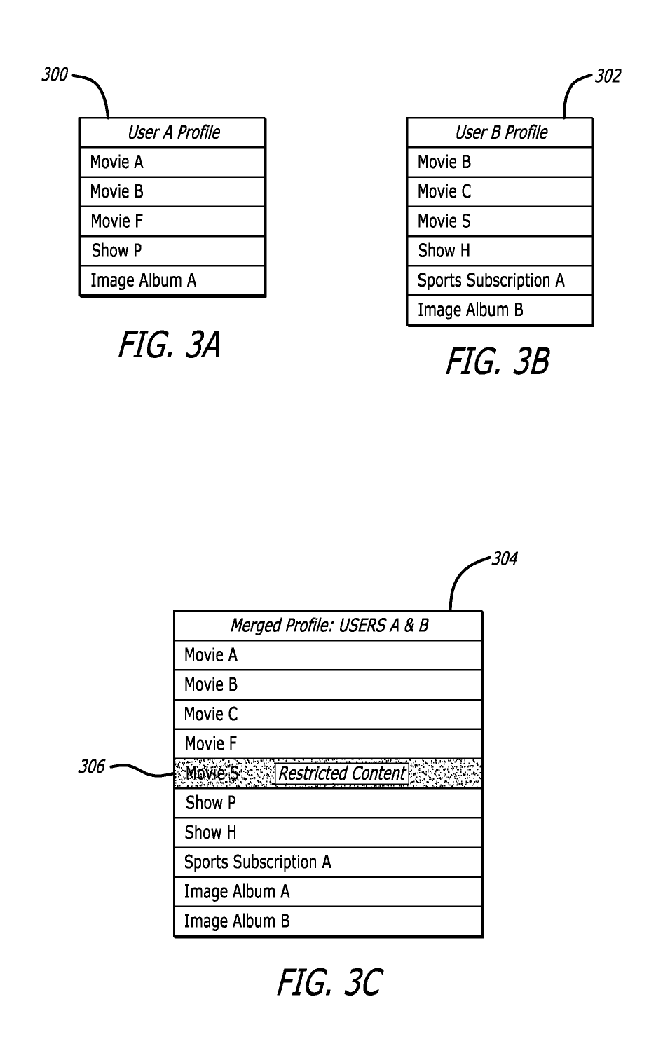

FIG. 2C illustrates an example wherein an application or software (either on second private device 204 or on server 120) causes prompt 214, asking second user 202 whether they would like to apply user B profile 216 to shareable device 108, to be displayed. In this example, second user 202 selects ‘Yes’ to have user B profile 216 applied to shareable device 108, which is shown in FIG. 2D. Accordingly, FIG. 2D illustrates an example wherein user A profile 116 and second user B profile 216 have been merged on shareable device 108 to create a merged profile. User 102 and second user 202 can, after user A profile 116 and second user B profile 216 have been merged, can view content available through each user profile on shareable device 108, which is illustrated with respect to FIGS. 3A-3C.

FIG. 3A illustrates example content 300 associated with user A profile 116 and FIG. 3B illustrates example content 302 associated with user B profile 216 in accordance with at least one embodiment. In this example, content 300 associated with user A profile 116 includes Movies A, B, F, Show P, and Image Album A and content 302 associated with user B profile 216 includes Movies B, C. S, Show H, Sports Subscription A, and Image Album B. Since these profiles are merged, the content from these profiles is available on shareable device 108. Accordingly, FIG. 3C illustrates example merged content 304 available on shareable device 108 after user A profile 116 and second user B profile 216 have been a merged. The merged profile, therefore, includes Movies A, B, C, F, Show H and P, Sports Subscription A, and Image Albums A and B.

Merged content 304, in this example, does not include Movie S. Accordingly, there can be various settings and profile priorities associated with a merged profile. In one example, there could be a device hierarchy based on permissions. For example, a child's private device may contain content restrictions that prevent a child from viewing violent content, adult content, or content associated with explicit language, where a parent's device does not. Accordingly, in this example, a profile restriction has been applied to merged content 304 preventing Movie S from being viewable on shareable device 108 based on Movie S containing restricted content 306. In such an instance, the content available on shareable device 108 will be accessible by multiple users (e.g., family members in a household, members of a club, etc.) and each user may have different levels of preferences or privileges. Further, shareable device 108 may also connect to a virtual store enabling users to make purchases. Accordingly, content viewable and actions performed on shareable device 108 may be managed to provide various levels of access control.

In at least one embodiment, the profile that is applied on a shareable device first could also dictate which user preferences are displayed or reflected most prominently. For example, if a first user has selected a first menu theme for their profile and a second user has selected a second menu theme, the merged profile could include the first menu theme since the first user's profile was applied before the second user's profile. Alternatively, there could be a default theme for merged profiles or the shareable device could apply the theme of the profile most often profiled on the shareable device among profiles comprising the merged profile. Further, in both menu theme, preferences, settings, content, or any subset of the same, a priority setting could be applied that prioritizes a particular private device over another. Therefore, when a first private device is profiled on a shareable device and a second private device having priority over the first device is subsequently profiled on the shareable device, the profile of the first private device could be removed and the profile of second private device profiled as its substitute.

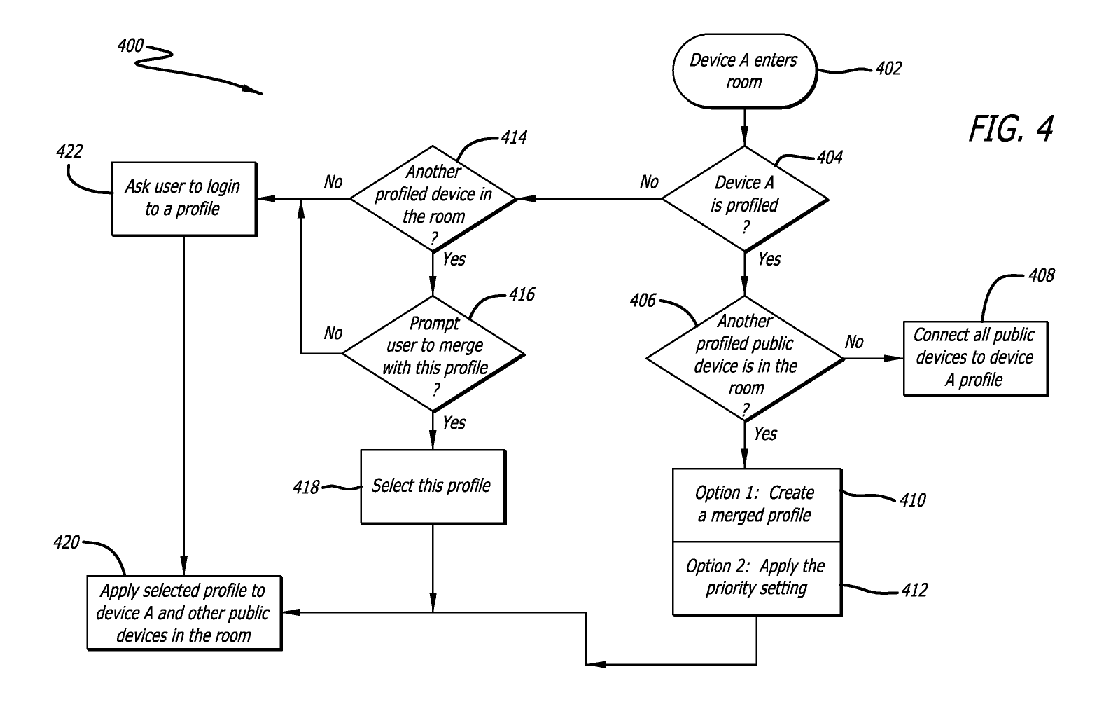

FIG. 4 illustrates an example process 400 for synchronizing user profiles that can be used in accordance with various embodiments. It should be understood that, for this and other processes discussed herein, there can be additional, fewer, or alternative steps, performed in similar or alternative steps, or in parallel, within the scope of the various embodiments unless otherwise stated. In this example, a private Device A enters a room 402. In one example, Device A could detect the presence of other computing devices or, when Device A enters the room, the presence of Device A may be detected by another device already residing in the room.

In one example, a public device already residing in the room may determine whether Device A entering the room is profiled 404 (e.g., whether Device A is associated with a user profile). This determination may also include, for example, whether Device A is a public or a private device. In this example, if Device A is associated with a user profile, a search for public devices associated with a user profile is conducted to determine whether there are any other profiled devices proximate to Device A 406. In this example, if there are one or more public devices in the room and they are not associated with a user profile, Device A profile is provided or pushed to each of the one or more public devices 408.

If at least one of the public devices includes a user profile that is different to the user profile of Device A entering the room, then the user profile on the public device can create a possible conflict with the profile of Device A. The conflict may be resolved according to the following action. If there is a profiled private device in the room, the first option may include using a merged profile that combines Device A profile with other private user profiles present in the room into one merged profile 410. In one example, upon merging the profiles, a notification or visual queue could be displayed, an audible alert could be played, a vibration could be generated, and the like. This merged user profile can, for example, represent a family profiled experience. In this example, each family member may have access to copyright content that varies, depending on, for example, subscription plan, purchases, etc. In one example, the merged profile can combine this copyrighted content from each family member. In another example, the merged profile may only combine the copyright content commonly owned by family members. In another example, if a public device is associated with more than one profile, the user of Device A can be prompted to determine whether the user would like to additionally associate the user profile of Device A to the public device. Further, among all user profiles associated with the public device, the user could be additionally prompted to determine whether the user could like to choose a priority profile for the public device.

Accordingly, the second option includes using a profile priority established at system level. For, if there are other profiled public devices present, a priority setting can be applied 412 to determine whether one of the profiles is a dominant profile relative to the other profiles. If one of the profiles is a dominant profile relative to the other profiles, the settings, preferences, content, etc. associated with the dominant profile will be applied and the same associated with the other non-dominant profiles removed. The dominant or priority profile may then be applied to each public device in the room 420.

In this example, if Device A is public and is not currently associated with a user profile and there is another profiled device in proximity to Device A 414, the user of Device A can be prompted (e.g., a pop-up window is displayed) to determine whether the user would like to adopt the user profile of this device 416. If the user accepts the adoption of this user profile, this profile will be applied to Device A 418 and, subsequently to other public devices in the room 420. If the user does not accept this user profile 416, all remaining devices may be disconnected from their current user profiles and the user is prompted for their user profile login information 422. Accordingly, once the user logs into their user profile, this profile will be applied to Device A and, as well as applied to other public devices in the room 420. Thus, when a user enters a room, Device A can cause all public devices to connect to their user profile. This process can be initiated automatically and initiated each time a computing device detects a second computing device.

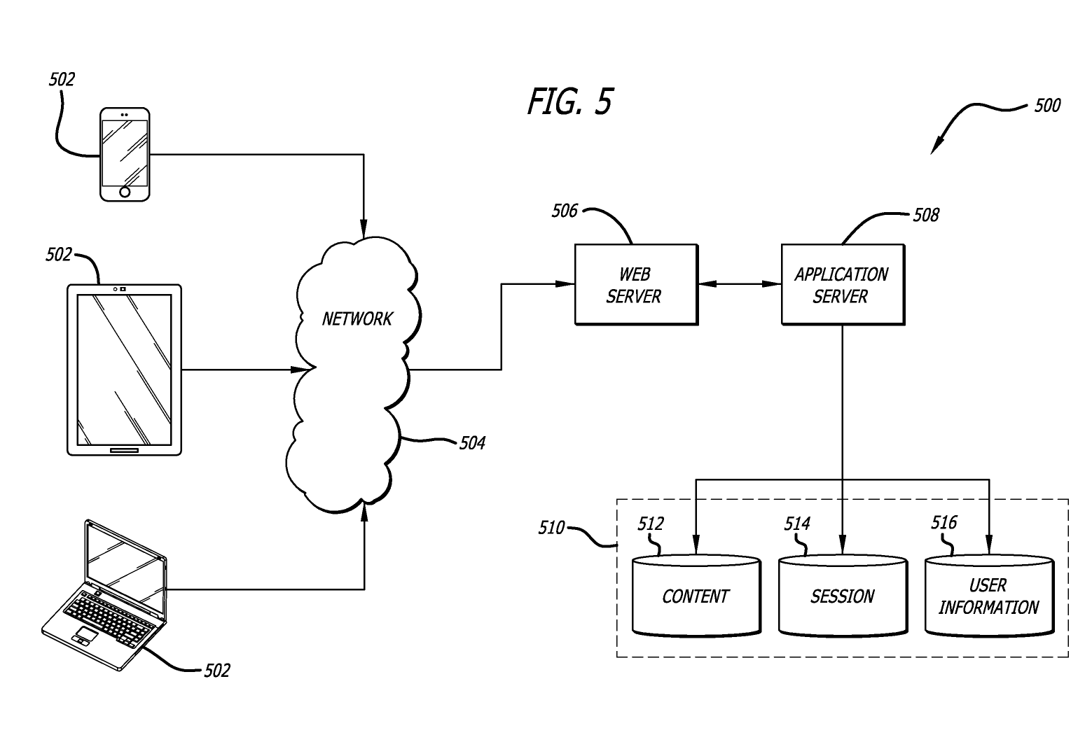

Different approaches can be implemented in various environments in accordance with the described embodiments. For example, FIG. 5 illustrates an example of an environment 500 for implementing aspects in accordance with various embodiments. As will be appreciated, although a Web-based environment is used for purposes of explanation, different environments may be used, as appropriate, to implement various embodiments. The system includes an electronic client device 502, which can include any appropriate device operable to send and receive requests, messages or information over an appropriate network 504 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. The network could be a “push” network, a “pull” network, or a combination thereof. In a “push” network, one or more of the servers push out data to the client device. In a “pull” network, one or more of the servers send data to the client device upon request for the data by the client device. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 506 for receiving requests and serving content in response thereto, although for other networks, an alternative device serving a similar purpose could be used, as would be apparent to one of ordinary skill in the art.

The illustrative environment includes at least one application server 508 and a data store 510. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server 508 can include any appropriate hardware and software for integrating with the data store 510 as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server 506 in the form of HTML, XML or another appropriate structured language in this example. The handling of all requests and responses, as well as the delivery of content between the client device 502 and the application server 508, can be handled by the Web server 506. It should be understood that the Web and application servers are not required and are merely example components, as structured code discussed herein can be executed on any appropriate device or host machine as discussed elsewhere herein.

The data store 510 can include several separate data tables, databases or other data storage mechanisms and media for storing data relating to a particular aspect. For example, the data store illustrated includes mechanisms for storing content (e.g., production data) 512 and user information 516, which can be used to serve content for the production side. The data store is also shown to include a mechanism for storing log or session data 514. It should be understood that there can be many other aspects that may need to be stored in the data store, such as page image information and access rights information, which can be stored in any of the above listed mechanisms as appropriate or in additional mechanisms in the data store 510. The data store 510 is operable, through logic associated therewith, to receive instructions from the application server 508 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 502. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
detecting, by a first computing device, a second computing device, the first computing device being associated with a first user profile;
determining whether the second computing device is currently associated with one or more user profiles; and
causing, on the second computing device, a second user profile to be merged with the first user profile to create a merged profile in response to the second computing device being associated with the second user profile.

2. The computer-implemented method of claim 1, further comprising:
associating the second computing device with the first user profile in response to the second computing device not being associated with a user profile.

3. The computer-implemented method of claim 1, further comprising:
determining that the first user profile has a profile priority over the second user profile; and
substituting the second user profile for the first user profile on the second computing device.

4. The computer-implemented method of claim 1, further comprising:
applying a profile restriction preventing at least a portion of content associated with the second user profile from being viewable on the second computing device.

5. The computer-implemented method of claim 1, wherein the merged profile enables first content available through the first user profile and second content available through the second user profile to be viewable on the second computing device.

6. The computer-implemented method of claim 1, further comprising:
prompting a user of the first computing device to merge the first user profile with the second user profile on the second computing device to create the merged profile.

7. The computer-implemented method of claim 1, further comprising:
causing at least one of a notification to be displayed, an audible alert to be played, or a vibration to be generated upon creating the merged profile on at least one of the first computing device or the second computing device.

8. The computer-implemented method of claim 1, wherein information for the first user profile is provided to the second computing device by at least one of the first computing device or a server.

9. A non-transitory computer-readable storage medium storing instructions that, when executed by at least one processor, cause a computing device to:
cause a shareable device to be detected by a private computing device, the private computing device being associated with a first user profile;
determine whether the shareable device is currently associated with one or more user profiles;
if the shareable device is not associated with a user profile,
cause the shareable computing device to be associated with the first user profile;
if the shareable device is associated with a second user profile,
cause the shareable device to merge the second user profile with the first user profile to create a merged profile; and
cause a priority setting to be applied to the merged profile, the priority setting causing the second user profile to be substituted for the first user profile.

10. The non-transitory computer-readable storage medium of claim 9, wherein the instructions that, when executed by the at least one processor, cause the computing device to:
cause a prompt to be displayed to a user of the private computing device, the prompt prompting the user to at least one of apply the first user profile on the shareable device or merge the first user profile with the second user profile on the shareable device.

11. The non-transitory computer-readable storage medium of claim 9, wherein the instructions that, when executed by the at least one processor, cause the computing device to:
store user profile information for a plurality of users, the profile information including device information for each user profile; and
synchronize the user profile information on each computing device associated with a respective user profile.

12. The non-transitory computer-readable storage medium of claim 9, wherein the private computing device is at least one of a laptop computer, a smartphone, or a tablet computer, and the shareable device is at least one of a set top box or a television.

13. The non-transitory computer-readable storage medium of claim 9, wherein first content available through the first user profile is viewable on the shareable device when the shareable device is associated with the first user profile, and wherein the merged profile enables the first content available through the first user profile and second content available through the second user profile to be viewable on the shareable device.

14. The non-transitory computer-readable storage medium of claim 13, wherein the instructions that, when executed by the at least one processor, cause the computing device to:
cause a profile restriction to be applied to the merged profile, the profile restriction preventing at least a portion of at least one of the first content or the second content from being viewable on the shareable device based at least in part on at least one of the first content or the second content containing restricted content.

15. A computing system, comprising:
a processor; and
memory including instructions that, when executed by the processor, cause the computing system to:
receive, from a private device, a request to apply a first user profile on a shareable device;
determine whether the shareable device is currently associated with one or more user profiles; and
send, in response to the shareable device not being associated with a user profile, information for the first user profile to the shareable computing device.

16. The computing system of claim 15, wherein the instructions, when executed by the processor, further enable the computing system to:
store user profile information for a plurality of users, the profile information including device information for each user profile; and
synchronize the user profile information on each computing device associated with a respective user profile.

17. The computing system of claim 15, wherein the instructions, when executed by the processor, further enable the computing system to:
cause, in response to the shareable device being associated with a second user profile, a priority setting to be applied on the shareable device, the priority setting causing the second user profile to be substituted for the first user profile.

18. The computing system of claim 15, wherein the instructions, when executed by the processor, further enable the computing system to:
cause, in response to the shareable device being associated with a second user profile, the shareable device to merge the second user profile with the first user profile to create a merged profile.

19. The computing system of claim 18, wherein first content available through the first user profile is viewable on the shareable device when the shareable device is associated with the first user profile, and wherein the merged profile enables the first content available through the first user profile and second content available through the second user profile to be viewable on the shareable device.

20. The computing system of claim 19, wherein the instructions, when executed by the processor, further enable the computing system to:
cause a profile restriction to be applied to the merged profile, the profile restriction preventing at least a portion of at least one of the first content or the second content from being viewable on the shareable device based at least in part on at least one of the first content or the second content containing restricted content.
